(19) United States
(12) Patent Application Publication
(10) Pub. No.: US 2012/0236177 A1
(43) Pub. Date: Sep. 20, 2012

(54) ELECTRONIC APPARATUS, INFORMATION PROCESSING APPARATUS, AND INFORMATION PROCESSING METHOD

(75) Inventor: Hiroshi NISHIKAWA, Izunokuni-shi (JP)

(73) Assignee: Toshiba Tec Kabushiki Kaisha, Tokyo (JP)

(21) Appl. No.: 13/420,513

(22) Filed: Mar. 14, 2012

(30) Foreign Application Priority Data
Mar. 18, 2011 (JP) 2011-061718

(51) Int. Cl. H04N 5/76

(52) U.S. Cl. 348/231.3; 348/E05.024

(57) ABSTRACT

According to one embodiment, an electronic apparatus includes a camera, an image clipping unit, an information input unit, a recording unit and a display. The camera photographs an image. The image clipping unit clips a customer image from the image photographed by the camera. The information input unit inputs customer information which is made to correspond to the customer image. The recording unit records the customer image with the customer information. The display displays the customer image and the customer information.

### CROSS-REFERENCE TO RELATED APPLICATIONS

This application is based upon and claims the benefit of priority from prior Japanese Patent Application No. 2011-061718, filed on Mar. 18, 2011, the entire contents of which are incorporated herein by reference.

### FIELD

Embodiments described herein relate generally to an electronic apparatus, an information processing apparatus, and an information processing method, in which information relating to a customer in a restaurant or the like is processed.

### BACKGROUND

In recent years, in a restaurant such as a diner restaurant, a waitperson uses a handy terminal and receives an order from a customer. For example, the waitperson carries the handy terminal and goes to a customer seat, inputs a table number, and inputs article data of an article ordered by each customer. When the reception of the order is ended, the waitperson reads aloud the ordered items displayed on the handy terminal, and makes the customer confirm the ordered items. The waitperson confirms the ordered items, and then transmits the ordered article data to an order station from the handy terminal.

When the order is received using the handy terminal, if the orders of plural customers on one table are collectively taken, when dishes are served, it is impossible to determine which dish is served to which customer on the table. Then, hitherto, positions of seats (chair symbols, etc.) of each table are inputted in order to determine the relation between the seat position and the ordered item.

### BRIEF DESCRIPTION OF THE DRAWINGS

FIG. 1 is a system view showing the whole structure of an order entry system in an embodiment.

FIG. 2A, FIG. 2B and FIG. 2C are views showing an outer appearance structure of a handy terminal in the embodiment in a non-use state.

FIG. 3 is a view showing the outer appearance structure of the handy terminal in the embodiment in a use state.

FIG. 4 is a block diagram showing a functional structure of the handy terminal in the embodiment.

FIG. 5 is a block diagram showing a functional structure of an order station in the embodiment.

FIG. 6 is a view showing an example of table data recorded in the handy terminal in the embodiment.

FIG. 7 is a view showing an example of customer management data recorded in the handy terminal in the embodiment.

FIG. 8 is a view showing an example of terminal management data recorded in the order station in the embodiment.

FIG. 9 is a flowchart showing an operation for registering a new customer and receiving an order in the embodiment.

FIG. 10 is a flowchart showing the operation for registering the new customer and receiving the order in the embodiment.

FIG. 11 is a flowchart showing the operation for registering the new customer and receiving the order in the embodiment.

FIG. 12 is a view showing an example of a photographed image displayed on a touch screen display (LCD) in the embodiment.

FIG. 13 is a view showing an example in which customer images correlated with seat positions, together a table layout image, are displayed in the embodiment.

FIG. 14 is a flowchart showing an operation of the handy terminal at the time of normal use in the embodiment.

FIG. 15 is a flowchart showing the operation of the handy terminal at the time of normal use in the embodiment.

FIG. 16 is a flowchart showing the operation of the handy terminal at the time of normal use in the embodiment.

FIG. 17 is a view showing an example in which names of articles ordered by a customer are displayed in the embodiment.

FIG. 18 is a flowchart showing a process of the handy terminal corresponding to reception from the order station in the embodiment.

FIG. 19 is a flowchart showing a process of the order station in the embodiment.

### DETAILED DESCRIPTION

In general, according to one embodiment, an electronic apparatus comprises a camera, an image clipping unit, an information input unit, a recording unit and a display. The camera is configured to photograph an image. The image clipping unit is configured to clip a customer image from the image photographed by the camera. The information input unit is configured to input customer information which is made to correspond to the customer image. The recording unit is configured to record the customer image with the customer information. The display is configured to display the customer image and the customer information.

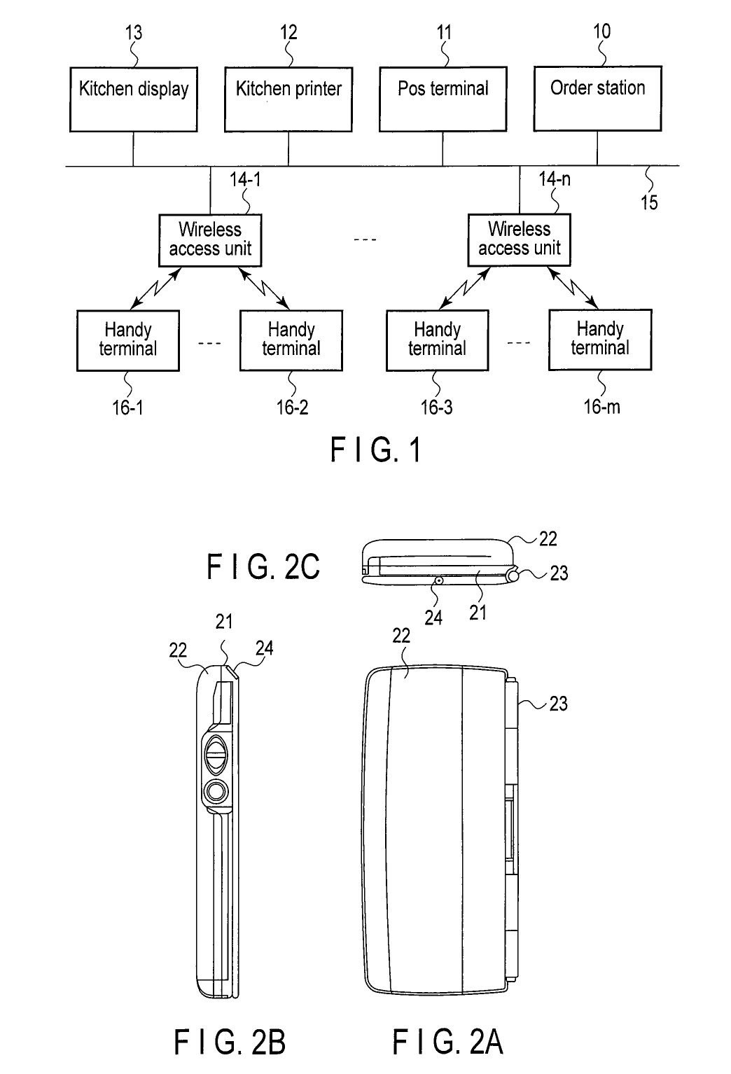

FIG. 1 is a system view showing the whole structure of an order entry system in an embodiment. The order entry system in the embodiment includes an order station 10 (information processing apparatus), a POS terminal 11, a kitchen printer 12, a kitchen display 13, plural wireless access units 14 (14-1, . . . , 14-n), and plural handy terminals 16 (16-1, 16-2, 16-3, . . . , 16-m).

The order station 10 is connected with the POS terminal 11, the kitchen printer 12, the kitchen display 13, and the access units 14 through, for example, a LAN (Local Area Network) 15, and data communication can be mutually performed. The handy terminal 16 can perform wireless communication with the wireless access unit 14, and can perform data communication with the order station 10 through the wireless access unit 14.

The order station 10 controls the whole order entry system, receives and manages information inputted in the handy terminal 16, and transmits various information to the POS terminal 11, the kitchen printer 12, the kitchen display 13 and the handy terminal 16 when necessary. The data received from the handy terminal 16 includes customer management data including ordered article data representing an ordered item, and customer image data representing a photographed customer.

The POS terminal 11 is installed on a check-out counter, and is a terminal for performing an accounting process for a customer.

The kitchen printer 12 is for indicating ordered menu items to a person existing in a kitchen and in charge of cooking, and prints a slip (cooking indicating slip) of contents corresponding to the ordered article data received from the order station 10. For example, customer information received from the order station 10 can also be simultaneously printed on the cooking indicating slip. Incidentally, although not shown, a customer check printer may also be provided in addition to the kitchen printer 12. The customer check printer is for indicating ordered menu items to a waitperson, and can simultaneously print the customer information together with the ordered article data received from the order station 10.

The kitchen display 13 is used for the person existing in the kitchen and in charge of cooking and the waitperson in a service area to confirm the ordered article and the customer information, and displays the ordered article data, the customer information and the like received from the order station 10.

The wireless access units 14 (14-1, . . . , 14-n) are dispersed and installed at plural places on the ceiling of a hall or the like so that wireless communication with the hand terminals 16 (16-1, 16-2, 16-3, . . . , 16-m) can be performed at any place in the store.

The handy terminal 16 is a terminal used for the waitperson to enter ordered article data representing ordered items received from the customer. The handy terminal 16 can input the ordered article data including menu codes to specify menu items and the number thereof while the ordered article data is made to correspond to the table number to specify the table. Besides, the handy terminal 16 can photograph a customer sitting at the table, and can record and display customer image data clipped from the photographed image. The customer image data and the ordered article data are correlated and recorded, so that the customer who ordered the article can be confirmed by displaying the customer image. The handy terminal 16 transmits the inputted ordered article data and the customer image data to the order station 10 through the wireless access unit 14.

Next, a detailed structure of the handy terminal 16 will be described.

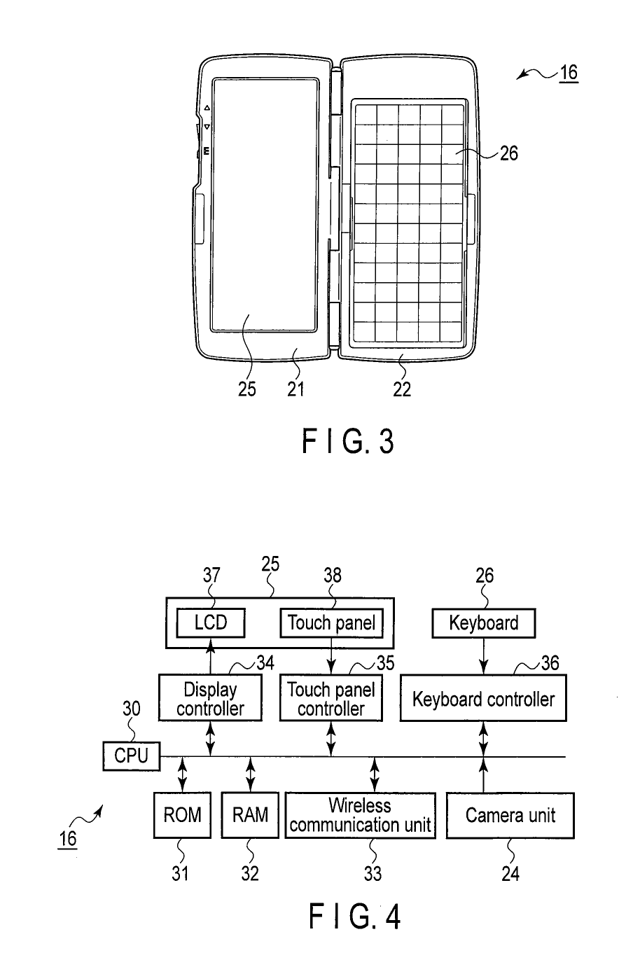

FIG. 2A, FIG. 2B and FIG. 2C are views showing an outer appearance structure of the handy terminal 16 in a non-use state in the embodiment. FIG. 2A is a plan view of the handy terminal 16, FIG. 2B is a left side view of the handy terminal 16, and FIG. 2C is a top view of the handy terminal 16. FIG. 3 is a plan view of the handy terminal 16 in an operation state. FIG. 3 is a view showing the outer appearance structure of the handy terminal 16 in the use state in the embodiment.

The handy terminal 16 is constructed such that a main body unit (first unit) 21 and an opening and closing unit (second unit) 22 are rotatably coupled through a hinge 23. The hinge 23 can change a state between a close state where the operation surfaces of the main body unit 21 and the opening and closing unit 22 face each other, and an open state where the operation surfaces of the main body unit 21 and the opening and closing unit 22 are opened.

As shown in FIG. 3, the operation surface of the main body unit 21 is provided with a touch screen display 25. In the touch screen display 25, an LCD and a touch panel are laminated and integrated, various information is displayed, and data corresponding to a touch operation can be inputted. Besides, the operation surface of the closing and opening unit 22 is provided with a keyboard 26. The keyboard 26 is provided with plural article keys for respective articles, a decision key, a mode key for setting the handy terminal 16 in various operation modes, and the like.

Besides, as shown in FIG. 2B and FIG. 2C, a camera unit 24 is provided at an upper end of the main body unit 21. The camera unit 24 is attached so that the front direction is within a photographing range when the waitperson carries and operates the handy terminal 16, for example, when the waitperson uses the handy terminal in a state where the touch screen display 25 is inclined by about 45. The camera unit 24 is used to photograph an image including a customer sitting at a table in the store.

FIG. 4 is a block diagram showing a functional structure of the handy terminal 16 in the embodiment.

The handy terminal 16 is constructed such that a CPU 30 to control the whole, a ROM 31 previously storing various programs including an information processing program and fixed data, and a RAM 32 used as a work area are connected through a bus line. Besides, the CPU 30 is connected with the camera unit 24, a display controller 34, a touch panel controller 35, a keyboard controller 36 and a wireless communication unit 33 through the bus line.

The CPU 30 executes the programs recorded in the ROM 31, and controls respective parts to realize various functions. The CPU 30 inputs an instruction from the waitperson by the operation of the keyboard 26, and further, displays operation buttons on the touch screen display 25 (LCD 37) according to various operation modes, and can input various instructions according to the touch operation to the operation buttons (touch panel 38).

The camera unit 24 photographs an image under the control of the CPU 30 and according to the operation of the waitperson to the touch screen display 25 or the keyboard 26, and inputs image data. Customer image data is clipped by the process of the CPU 30 from the image data photographed by the camera unit 24.

The display controller 34 drives and controls the LCD 37 based on the display image data, and causes the LCD 37 constituting the touch screen display 25 to display an image corresponding to the display image data. The touch panel controller 35 captures an input signal from the touch panel 38 constituting the touch screen display 25.

The keyboard controller 36 captures a key input signal from the keyboard 26. The wireless communication unit 33 controls wireless communication with the handy terminal 16.

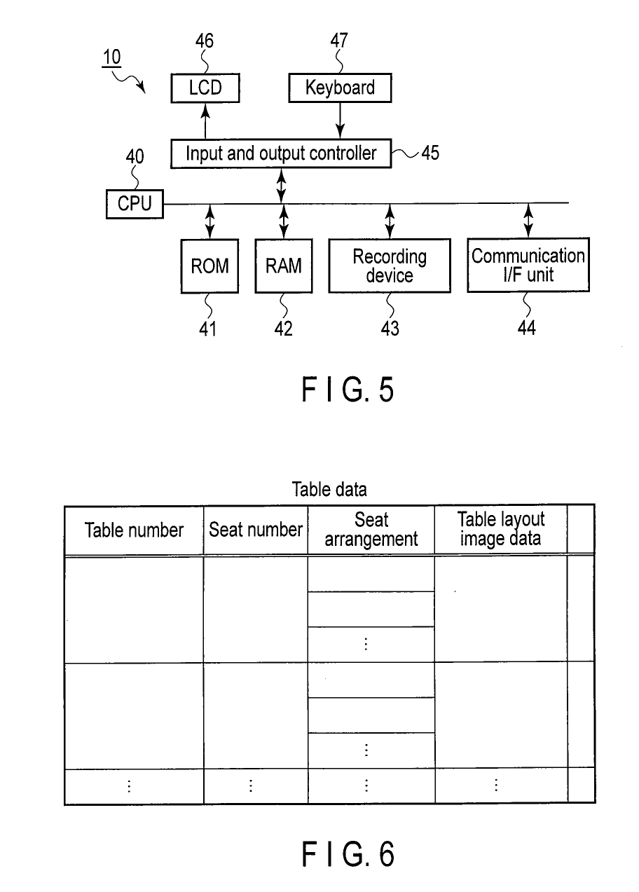

Next, the order station in the embodiment will be described. FIG. 5 is a block diagram showing a functional structure of the order station 10 in the embodiment.

The order station 10 is constructed such that a CPU 40 to control the whole, a ROM 41 previously storing various programs including an information processing program and fixed data, and a RAM 42 used as a work area or the like are connected through a bus line. Besides, the CPU 40 is connected with an input and output controller 45, a recording device 43, and a communication interface unit 44 through the bus line.

The CPU 40 executes the programs recorded in the ROM 41 or the recording device 43, and controls respective parts to realize various functions.

The input and output controller 45 drives and controls an LCD 46 based on display image data, and causes the LCD 46 to display an image corresponding to the display image data, and captures an input signal from a keyboard 47.

The recording device 43 is for recording data on a data rewritable recording medium such as a hard disk or a flash memory, and records ordered article data and customer information received from the handy terminal 16, or various programs and data.

The communication interface 44 controls data communication among the POS terminal 11, the kitchen printer 12, the kitchen display 13, and the wireless access unit 14.

FIG. 6 is a view showing an example of table data recorded in the handy terminal 16 in the embodiment.

In the table data, with respect to each of tables installed in the store, the number of seats, seat arrangement, table layout image data and the like are made to correspond to the unique table number previously determined for the table and are set. The table data is the data used for the handy terminal 16 to acquire the customer image data and to display the customer image on the touch screen display 25 (LCD 37).

The number of seats is the data representing the number of seats on which customers can sit and which are determined for each table.

The seat arrangement is the data representing positions of customers the number of which is equal to the number of seats which corresponds to the table shape. For example, in the case of a rectangular 6-seat table, three customers are arranged on each of the long sides. Customer images are clipped from the image photographed by the camera unit 24, and the arrangement of the respective customer images relative to the table can be determined by referring to the data of the seat arrangement.

The table layout image data is the data representing the shape of the table to be displayed in order to facilitate understanding of the arrangement of customers on the table when the customer images are displayed.

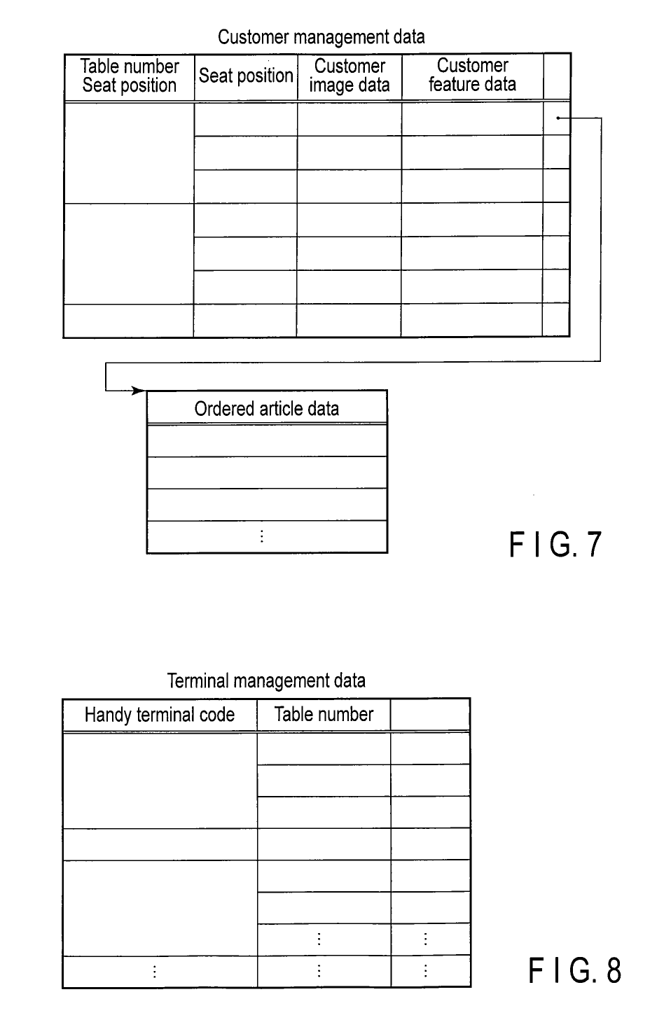

FIG. 7 is a view showing an example of customer management data recorded in the handy terminal 16 in the embodiment.

The customer management data is the data inputted by the handy terminal 16, and is recorded in the handy terminal 16, and is simultaneously transmitted to the order station 10 and is recorded. In the customer management data, for each table installed in the store (each place where an image is photographed by the camera unit 24), seat position, customer image data, customer feature data, ordered article data and the like are made to correspond to the unique table number previously determined for the table and are set.

The seat position is the data representing positions of respective customers sitting at the table. The seat position is detected when the customer image data is clipped from the image data photographed by the camera unit 24, or is specified by the operation of the waitperson to the touch screen display 25 or the keyboard 26.

The customer image data is the image data of each customer clipped from the image data photographed by the camera unit 24.

The customer feature data is the data inputted by the operation of the waitperson to the touch screen display 25 or the keyboard 26, and represents features (customer features) for identifying the customer. As the customer features, various items such as sexuality, age, color of clothes and hair style can be specified. Incidentally, since the respective customers can be identified by the customer image data, the input of the customer feature data can be arbitrarily executed.

The ordered article data is the data representing articles ordered by the customers, and are classified and set for the respective customers. That is, the ordered article data is correlated with the seat position and the customer image data, and is set in the customer management data.

Incidentally, the handy terminal 16 not only records the customer management data inputted by the operation of the waitperson but also transmits the data to the order station 10. Besides, the handy terminal 16 can receive and record customer management data transmitted from the order station 10, that is, the customer management data inputted by another handy terminal 16. For example, the handy terminal 16-1 can receive customer management data inputted by the handy terminal 16-2 through the order station 10. By this, the waitperson carrying the handy terminal 16-1 can serve the customers at the table served by the waitperson carrying the handy terminal 16-2 by using the customer management data received from the order station 10.

FIG. 8 is a view showing an example of terminal management data recorded in the order station 10 in the embodiment.

The terminal management data is the data for managing which handy terminal 16 (16-1, 16-2, 16-3, . . . , 16-m) records customer management data of which table. The table number corresponding to the customer management data recorded in each handy terminal 16 is made to correspond to the unique handy terminal code for identifying the handy terminal 16 and is set.

The order station 10 updates the terminal management data according to transmission and reception of the customer management data to and from the handy terminal 16, and refers to the terminal management data and instructs update or deletion of the customer management data recorded in the handy terminal 16.

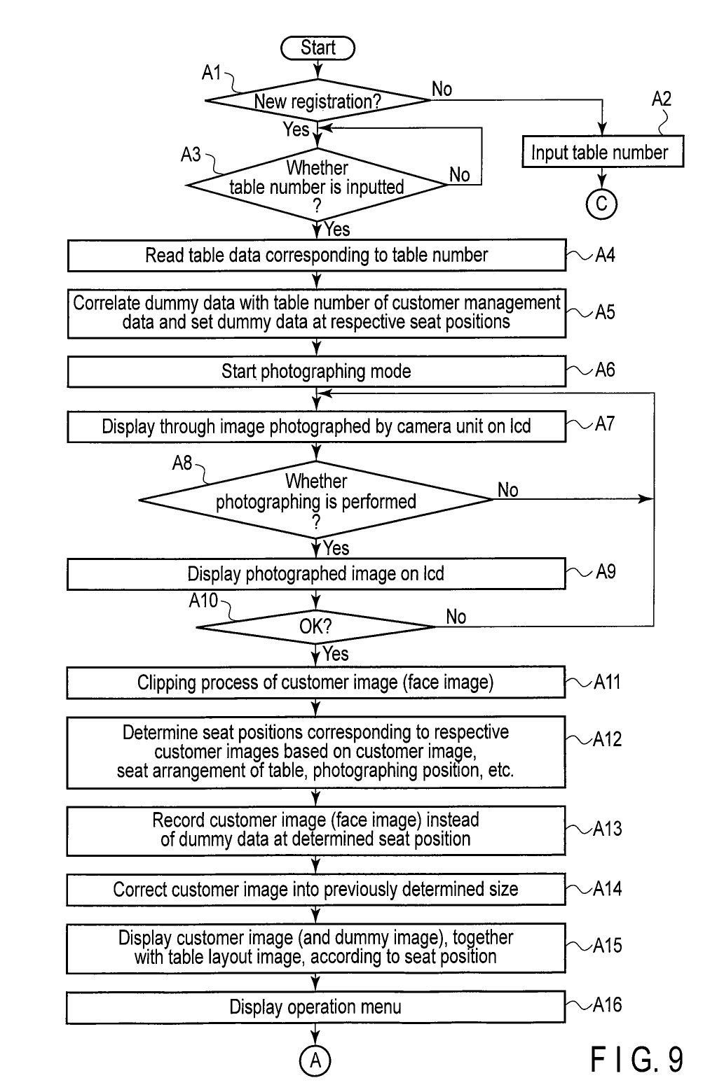

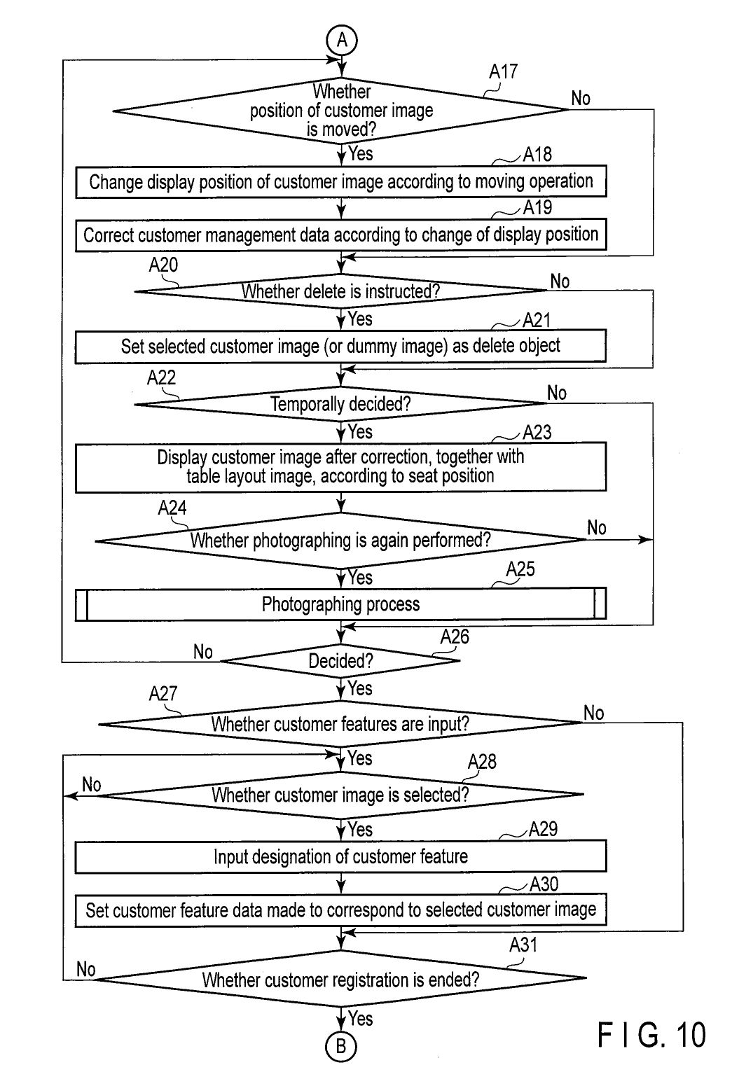

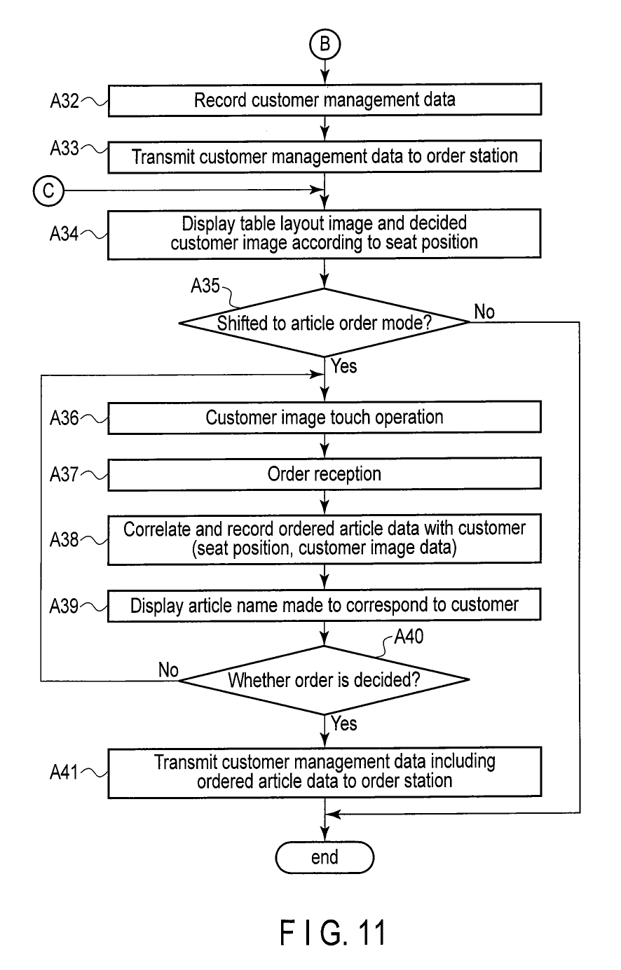

Next, an operation of the handy terminal 16 in the embodiment will be described with reference to flowcharts shown in FIG. 9, FIG. 10 and FIG. 11. The flowcharts shown in FIG. 9 to FIG. 11 show an operation for registering a new customer and receiving an order.

If the registration of a new customer is requested by the operation of the keyboard 26 (or the touch screen display 25) (Yes at Act A1), the CPU 30 of the handy terminal 16 shifts to a new registration mode, and receives the input of the table number of a table as a registration object.

If the table number is inputted (Yes at Act A3), the CPU 30 reads the table data corresponding to the table number (Act A4), and causes dummy data to correspond to the table number of the customer management data and sets the dummy data at the respective seat positions (Act A5). For example, if the number of seats of the table number 1 in the table data is 6, the dummy data for 6 seats are made to correspond to the table number 1 and are set in the customer management data.

Here, the CPU 30 starts a photographing mode, and the camera unit 24 starts photographing of an image (Act A6). The CPU 30 causes the LCD 37 to display the through image photographed by the camera unit 24. The waitperson sees the through image displayed on the LCD 37, and can adjust the direction of the handy terminal 16 (the camera unit 24) so that all customers sitting at the table are included in the photographing range (No at Act A8).

Here, if photographing execution (shutter on) is instructed by a specified key provided on the keyboard 26 (Yes at Act A8), the CPU 30 causes the LCD 37 to display a photographed image based on the image data photographed by the camera unit 24 (Act A9). The waitperson sees the photographed image displayed on the LCD 37 and can confirm whether the face portions of the customers are photographed. As a result, if the face portions of the customers are not photographed, the photographed image is cancelled and photographing can be again performed similarly to the foregoing (No at Act A10).

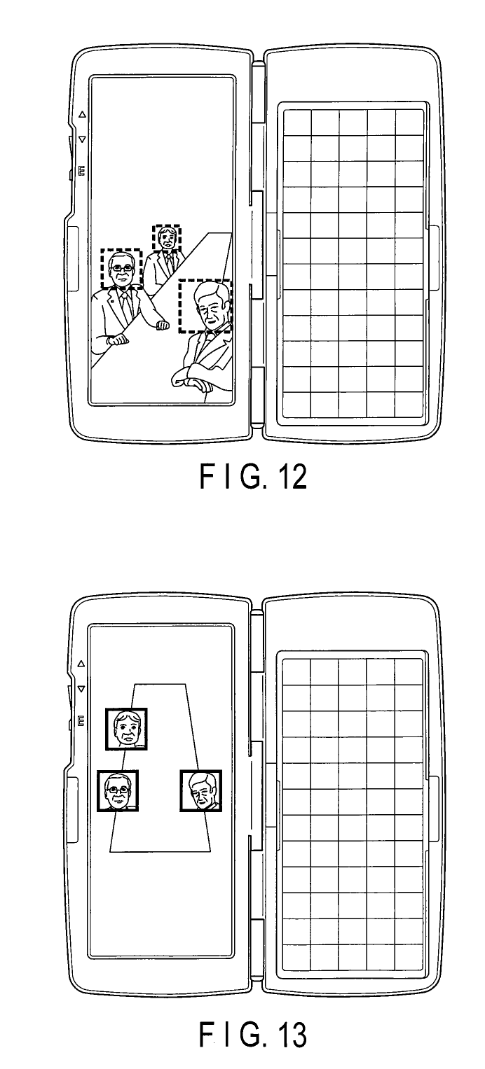

FIG. 12 shows an example of a photographed image displayed on the touch screen display 25 (LCD 37). In the example shown in FIG. 12, the image including three customers is photographed.

Here, if the waitperson inputs an instruction to accept the photographed image (Yes at Act A10), the CPU 30 executes a clipping process to clip customer images from the photographed image (Act A11). In the clipping process in the embodiment, for example, a face image is extracted from the photographed image based on a human face pattern (shape and arrangement of eyes, a nose, a mouth and the like), and the extracted face image and the head image are clipped as the customer image. For example, portions of rectangular frames indicated by broken lines shown in FIG. 12 are clipped as the customer images.

Incidentally, as the process of extracting the customer image (face image), another existing image process can also be used. Besides, the portion clipped as the customer image is not limited to the face image (and the head part), and a portion including a part of the upper body may be clipped. If the portion including the upper body is clipped, not only the face of the customer but also the clothes (color and shape) of the customer can be confirmed from the customer image.

When the clipping process of the customer image is completed, the CPU 30 determines the seat positions corresponding to the respective customer images based on the customer images, the seat arrangement of the table, the photographing position and the like (Act A12). The seat positions corresponding to the respective customer images are calculated based on, for example, the arrangement relation (up, down, right and left) of the customer images in the photographed image, the positions of the customer images relative to the image corresponding to the table, and the photographing position specified by the height of the handy terminal 16 held by the waitperson and the position relative to the table.

The CPU 30 records the customer image (face image) data instead of the dummy data at the determined seat positions in the customer management data (Act A13). The CPU 30 corrects the customer images into a previously determined size (Act A14), and causes the LCD 37 to display the corrected customer images, together with the table layout image displayed based on the table layout image data, according to the seat positions (Act A15).

FIG. 13 shows an example in which the customer images made to correspond to the seat positions, together with the table layout, are displayed. As shown in FIG. 13, the customer images, together with the shape of the table, are displayed, so that the correspondence between each of the customers and the customer image can be easily identified.

Here, the CPU 30 displays an operation menu and receives an instruction of a next process (Act A16). In the operation menu, correction of the customer image displayed together with the table layout, input of the customer features, shift to an article order mode and the like can be instructed.

Here, if an operation of moving the customer image displayed together with the table layout, that is, an operation of moving (drag) the customer image while the customer image is kept touched is performed (Yes at Act A17), the CPU 30 changes the display position of the customer image according to the movement operation (Act A18). That is, if the seat position determined for the customer image is not correct, the seat position of the customer image can be arbitrarily corrected by the operation of the waitperson. The CPU 30 corrects the correspondence relation between the seat position and the customer image data in the customer management data according to the change of the display position of the customer image (Act A19). Here, if registration decision is instructed from the operation menu (Yes at Act A26), the CPU 30 ends the registration of the customer image.

On the other hand, if a delete instruction of the customer image is entered from the operation menu (Yes at Act A20), the CPU 30 sets the customer image selected by the touch operation to the touch screen display 25 as the delete object (Act A21). For example, if an image of an unnecessary person, for example, an image of another customer sitting at an adjacent table is included in the photographed image, there is a case where the image of this customer is clipped and is displayed as the customer image. In this case, the waitperson can arbitrarily select the unnecessary customer image from the displayed customer image by the touch operation. Here, plural customer images can be simultaneously selected as the delete object.

Here, if the registration decision is instructed from the operation menu (Yes at Act A26), the CPU 30 deletes the customer image data set as the delete object from the customer management data and ends the registration of the customer image.

Besides, if temporal decision is instructed from the operation menu (Yes at Act A22), the CPU 30 displays the corrected customer image, together with the table layout, according to the seat position (Act A23). That is, the waitperson is enabled to confirm the state after the customer image is moved or the unnecessary customer image is deleted. Here, if the registration decision is instructed from the operation menu (Yes at Act A26), the CPU 30 ends the registration of the customer image.

Incidentally, when the customer images of all customers could not be photographed, the customers are again photographed and the customer images can be inputted. If photographing execution is again instructed from the operation menu (Yes at Act A24), the CPU 30 again executes the foregoing photographing process, that is, the process of Act A6 to A26. However, in the second photographing process, the temporarily decided relation between the customer image data and the seat position is not changed, and the customer image data is captured at the seat position where the dummy data is set.

Incidentally, also in the second photographing process, as stated above, all clipped customer images are presented to the waitperson, and an unnecessary customer image may be made to be selected.

Besides, although the unnecessary customer image is selected in the foregoing description, a necessary customer image is selected, and the other image may be set as a delete object.

Here, if the registration decision is instructed from the operation menu (Yes at Act A26), the CPU 30 ends the registration of the customer images.

If customer feature input is instructed from the operation menu (Yes at Act A27), the CPU 30 displays a menu screen for customer feature input, and can receive the designation of the customer features. The customer features are, for example, features determined by the waitperson after the waitperson sees the customer, and the relevant features are specified from the menu screen based on the subjectivity of the waitperson. As the customer features, for example, with respect to the sexuality, age, color of clothes, hair style, body type and the like, the relevant ones are specified.

After the customer image displayed on the touch screen display 25 is selected by the touch operation (Yes at Act A28), when the customer features are specified from the menu screen (Act A29), the CPU 30 causes the customer features to correspond to the selected customer image data (seat position) in the customer management data and sets the customer features as the customer feature data (Act A30).

In this way, the customer features are made to correspond to the customer image data and are set in the customer management data, so that the customer features can be displayed when necessary, for example, when the identification of the customer is difficult from only the customer image, and the customer can be certainly identified.

Here, if the end of the customer registration is instructed from the operation menu (Yes at Act A31), the CPU 30 records the customer management data in which the seat position, the customer image data, and the customer feature data are correlated for each customer and are made to correspond to the first inputted table number (Act A32). Besides, the CPU 30 transmits the newly added customer management data to the order station 10 through the wireless communication unit 33 (Act A33). The order station 10 records the customer management data received from the handy terminal 16.

Based on the decided customer management data, the CPU 30 displays the table layout image and the decided customer image on the LCD 37 according to the seat position (Act A34). Here, the process of the customer registration can be ended, or the order of an article can be continuously received.

The process of the customer registration is ended, and after the waitperson shifts to another operation, if the order from the customer of the same table is received, the table number is inputted. When the table number is inputted (FIG. 9, Act A2), based on the customer management data, the CPU 30 displays the table layout image and the customer image on the LCD 37 according to the seat position (Act A34).

When the ordered article is indicated in the state where the table layout image and the customer image are displayed, the CPU 30 shifts to the article order mode (Yes at Act A35). Here, after the customer image as an object from which an order is received is selected by the touch operation (Act A36), when the ordered article is specified by the operation to the keyboard 26 (Act A37), the CPU 30 causes the ordered article data to correspond to the customer (seat position, customer image data) in the customer management data and records the ordered article data (Act A38).

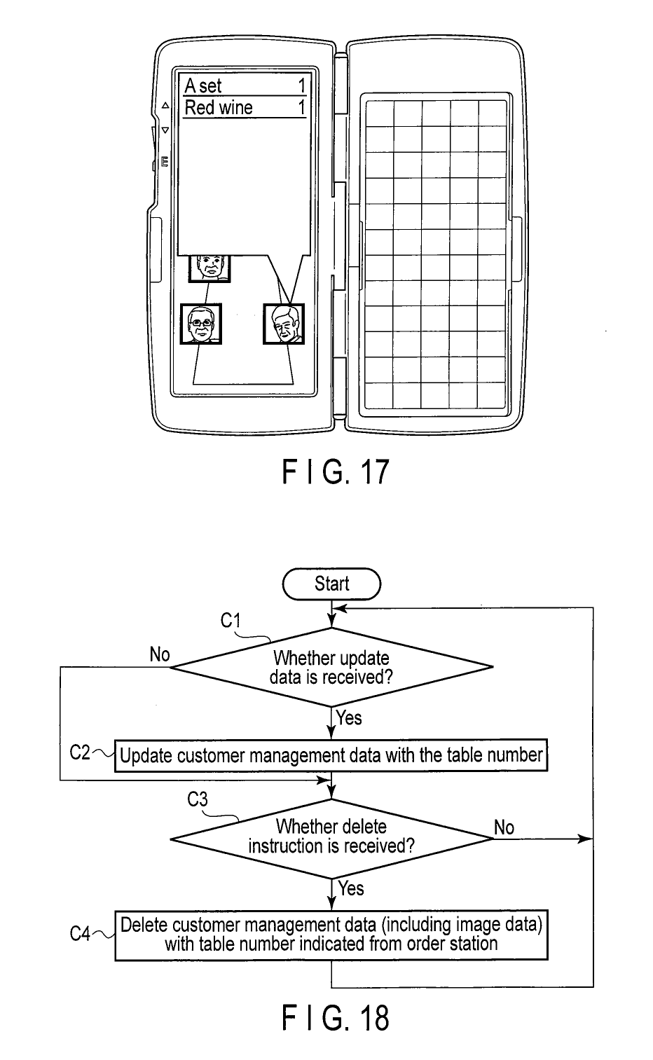

The CPU 30 causes the LCD 37 to display the article name made to correspond to the customer according to the inputted ordered article data (Act A39). FIG. 17 shows an example in which the ordered article name made to correspond to the customer is displayed. In the example shown in FIG. 17, the customer sitting on the right side of the table ordered an “A set” and a “red wine”.

Also with respect to another customer, similarly, the customer image is touched so that the customer is set as an object from which an order is received, and the ordered article data representing the ordered article inputted by the operation of the keyboard 26 is sequentially made to correspond to the customer and is set in the customer management data (Act A36 to A39).

In this way, when the order reception from the customer is completed and the order decision is instructed (Act A40), the CPU 30 transmits the customer management data including the ordered article data to the order station 10 through the wireless communication unit 33 (Act A41). If the customer management data received from the handy terminal 16 is already received (the customer management data of the same table number is already recorded), the order station 10 updates the ordered article data included in the customer management data according to the newly received ordered article data.

In this way, in the handy terminal 16 of the embodiment, the customer image is clipped from the image of the photographed customer and is displayed on the touch screen display 25, and the order made to correspond to the customer image can be received. Since the customer image and the ordered article are correlated, it becomes possible to easily recognize which customer ordered which article.

Incidentally, in the foregoing description, although the customer image and the ordered article are correlated, the customer image may be correlated with other information as customer information in addition to the customer feature data and may be recorded. For example, a special request or a claim notified to the waitperson, a message, information noticed by the waitperson and to be notified to another waitperson, and the like are enabled to be inputted by the operation of the touch screen display 25 or the keyboard 26, and can also be recorded as the customer management data made to correspond to the customer image into the handy terminal 16 and the order station 10.

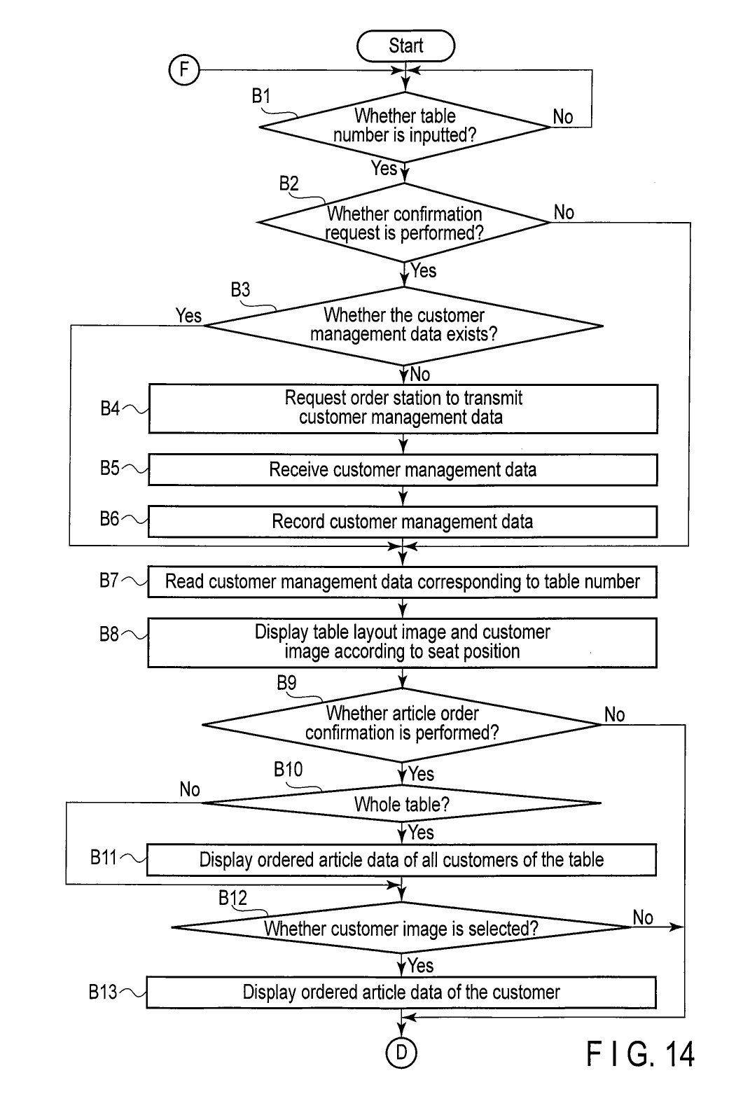

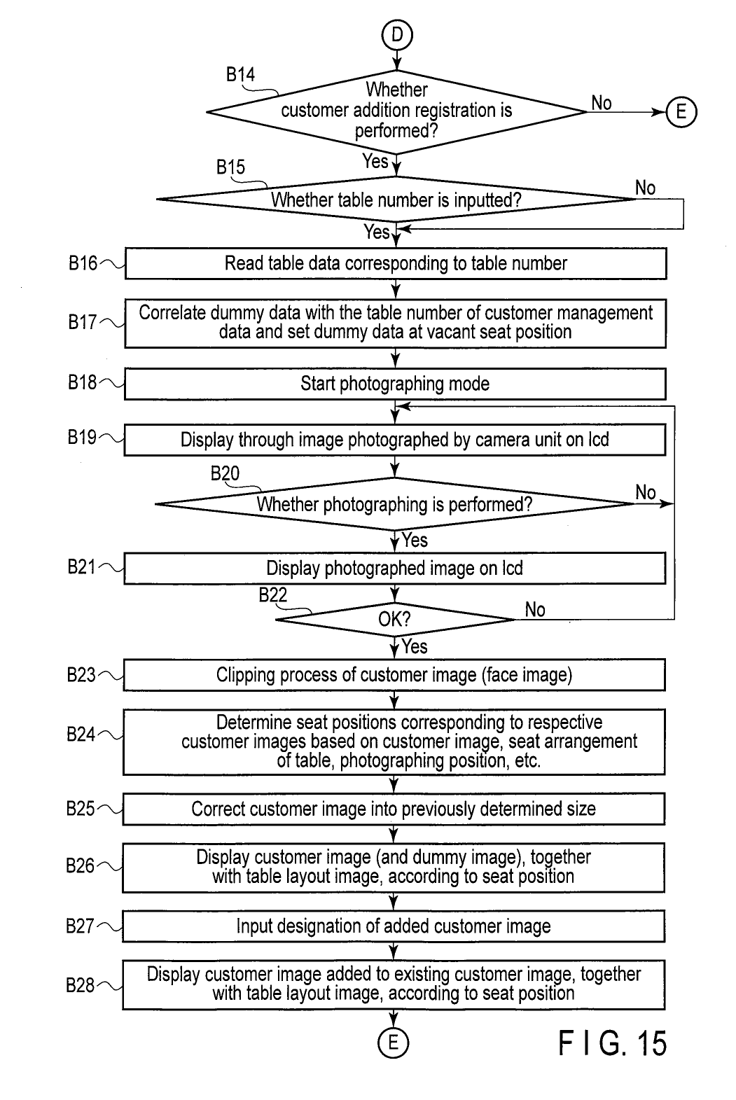

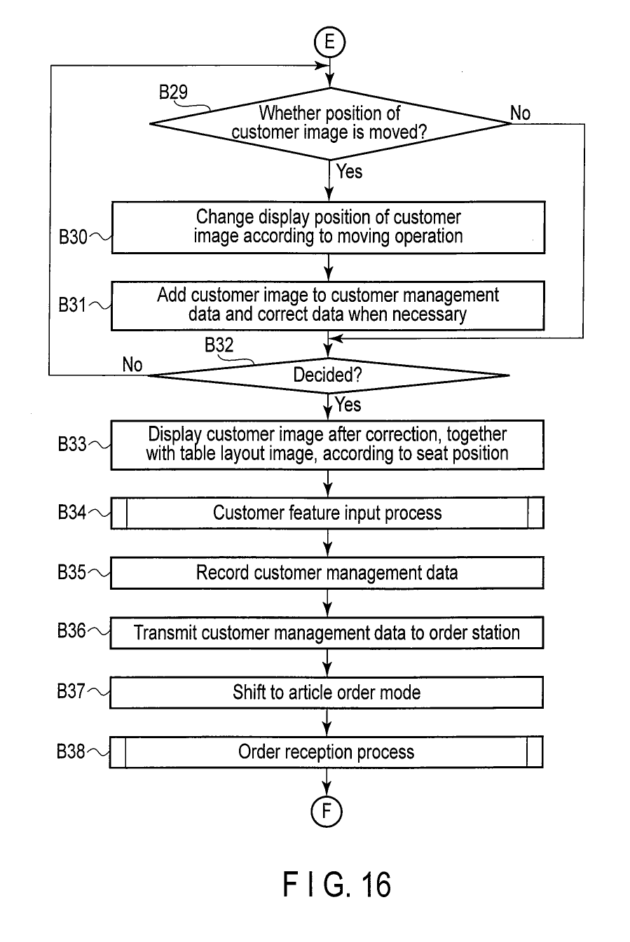

Next, an operation of the handy terminal 16 in the embodiment at the time of normal use will be described with reference to flowcharts shown in FIG. 14, FIG. 15 and FIG. 16.

At the time of normal use of the handy terminal 16, for example, when the table number is inputted, processes for confirmation of the customer management data (including the ordered article data) recorded correspondingly to the table number, for additional registration of a customer, and for changing the seat position can be performed. The CPU 30 displays the operation menu on the LCD 37, and executes the respective processes by the touch operation to the touch screen display 25.

If the table number is inputted (Yes at Act B1), and a confirmation request is instructed by the operation of the keyboard 26 (or the touch screen display 25), the CPU 30 of the handy terminal 16 shifts to a confirmation mode, and determines whether the customer management data corresponding to the inputted table number is recorded.

Here, if the customer management data corresponding to the table number is recorded (Yes at Act B3), the CPU 30 reads the customer management data corresponding to the table number (Act B7), and causes the LCD 37 to display the table layout image and the customer image arranged according to the seat position (Act B8). By this, the customer of the table specified as the object of the confirmation and the seat position can be confirmed through the customer image.

Here, if the confirmation request of the ordered article is instructed (Act B9), and the whole table is specified as the object of the confirmation (Yes at Act B10), the CPU 30 reads the ordered article data of all customers of the table and displays the data on the LCD 37 (Act B11). Incidentally, in the ordered article data set in the customer management data, an ordered article which is not yet served can be confirmed (customer management data is updated by a process mentioned below).

On the other hand, if the customer image is selected as the object of the confirmation (Yes at Step B12), the CPU 30 reads the ordered article data of the customer and displays the data on the LCD 37 (Act B13). FIG. 17 shows the example in which the name of the article ordered by the customer is displayed. The example shown in FIG. 17 shows that the customer sitting on the right side of the table orders an “A set” and a “red wine”, and the ordered articles are not yet served.

If the customer management data with the table number inputted as the confirmation object is not recorded (No at Act B3), that is, in the case of the handy terminal 16 in which the process of the customer new registration is not performed, the CPU 30 requests the order station 10 to transmit the customer management data corresponding to the inputted table number (Act B4).

When receiving the customer management data through the wireless communication unit 33, the CPU 30 records the data together with customer management data of another table (Act B5). Hereafter, similarly to the above, the same process as the case where the customer management data is previously recorded is performed (Act B7 to B13).

By this, articles ordered in the respective tables (and not served) can be confirmed at an arbitrary timing by using the handy terminal 16.

Next, if customer addition registration is instructed (Yes at Act B14), the CPU 30 executes a process of adding a new customer to the customer management data corresponding to the inputted table number (Act B16 to B26). Incidentally, input of another table number is received, and the table as the object of the customer addition can be changed (Act B15).

The process of Act B16 to B26 is similar to the process at the time of the customer new registration shown at Act A4 to A15 of FIG. 9, and the detailed description thereof is omitted.

The CPU 30 causes the LCD 37 to display the customer image clipped from the image photographed again, together with the table layout image displayed based on the table layout image data, according to the seat position (Act B26). At least the face image of the customer to be added is photographed at the time of photographing, so that the customer image of the customer is displayed.

Here, if the customer image to be added is selected by the touch operation (Act B27), the CPU 30 adds the new customer information to the existing customer image, and causes the LCD 37 to display the new customer image, together with the table layout image, according to the seat position (Act B26). Incidentally, among the customer images clipped from the image photographed again, customer images not selected as the addition image are all deleted. If the seat position of the customer image to be added overlaps with the seat position of the existing customer image, the new customer image is temporarily made to correspond to a vacant seat position and is displayed.

Here, if an operation of moving the customer image displayed together with the table layout, that is, an operation of moving (drag) the customer image while the customer image is kept touched is performed on the touch screen display 25 (Yes at Act B29), the CPU 30 changes the display position of the customer image according to the movement operation (Act B30). That is, if the seat position of the customer image to be added overlaps with the seat position of the existing customer image, or if the seat position of the existing customer is changed by the addition of the customer, the seat position of the customer image can be arbitrarily changed by the operation of the waitperson. The CPU 30 causes the new customer image data to correspond to the seat position and adds the data into the customer management data, and corrects the correspondence relation between the seat position and the customer image data in the customer management data according to the correcting operation when necessary (Act B31). Here, if the decision is instructed from the operation menu (Yes at Act B32), the CPU 30 ends the addition registration of the customer image, and displays the customer image after the correction, together with the table layout image, according to the seat position and according to the customer management data (Act B33).

Here, if the customer feature input is instructed from the operation menu, the CPU 30 displays a menu screen for customer feature input, receives the designation of customer features and can record the features (Act B34). The customer feature input process is similar to the process of Act A27 to A31 of FIG. 10 and the detailed description thereof is omitted. By this, the customer features can be arbitrarily recorded also for the newly added customer.

The CPU 30 records the customer management data after the correction (Act B35), and transmits the corrected customer management data to the order station 10 through the wireless communication unit 33 (Act B36). The order station 10 records the customer management data received from the handy terminal 16.

Further, if the ordered article is indicated, the CPU 30 shifts to the article order mode (Act B37), and can receive an order from the added customer or from another customer (Act B38). The order reception process is similar to the process of Act A35 to A40 of FIG. 11, and the detailed description thereof is omitted.

Incidentally, in the state where the table layout image and the customer image arranged according to the seat position are displayed (Act B8), if the operation (drag operation) of moving the customer image is performed (Yes at Act B29), the CPU 30 changes the display position of the customer image according to the movement operation, and corrects the customer management data (Act B30, B31). That is, if the customer moves the seat position, the waitperson can correct the relation between the seat position and the customer image data in the customer management data each time.

In this way, at the time of normal use of the handy terminal 16, by specifying the table number, with respect to the customer management data of the table, the processes for the confirmation of the customer management data (including the ordered article data), the customer addition registration, and the change the seat position can be arbitrarily performed.

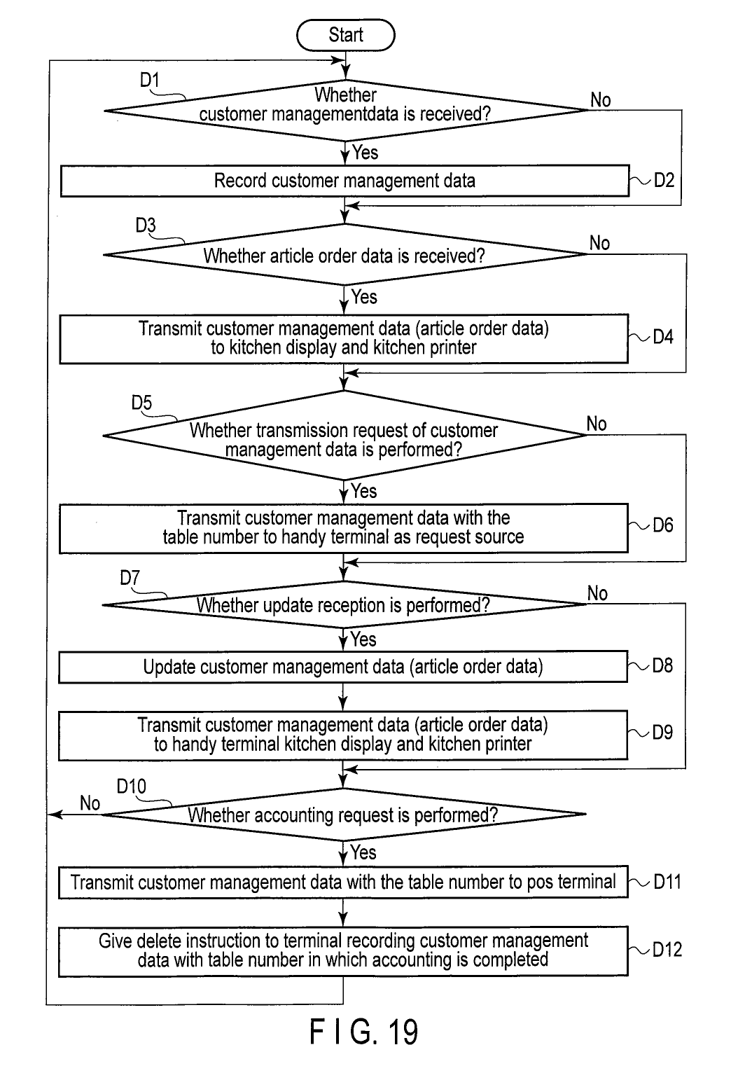

Next, the link between the handy terminal 16 and the order station 10 will be described. FIG. 18 is a flowchart showing a process of the handy terminal 16 according to the reception from the order station 10, and FIG. 19 is a flowchart showing a process of the order station 10.

When receiving the customer management data corresponding to a non-registered table number from the handy terminal 16 (Yes at Act D1), the order station 10 (CPU 40) records the new customer management data in the recording device 43 (Act D2). In the terminal management data, the order station 10 causes the table number corresponding to the received customer management data to correspond to the handy terminal code for identifying the handy terminal 16 as the transmission source of the customer management data, and sets the terminal number.

Further, when receiving the ordered article data with respect to the new customer management data (table number) (Yes at Act D3), the order station 10 records the ordered article data in the customer management data, and transmits the customer management data (ordered article data) to the kitchen printer 12 and the kitchen display 13 (Act D4).

The kitchen printer 12 prints, for example, a cooking indicating slip for a person existing in the kitchen and in charge of cooking based on the customer management data (ordered article data) received from the order station 10. Incidentally, the kitchen printer 12 can print not only the list of ordered articles, but also the customer information including the customer image. If the customer information (customer image, customer features, etc.), together with the ordered articles, is printed, the customer ordered the articles can be certainly recognized.

Besides, the kitchen display 13 displays the list of the ordered articles for the person in charge of cooking or the waitperson based on the customer management data received from the order station 10. Incidentally, the kitchen display 13 can display not only the list of the ordered articles but also the customer information including the customer image. If the customer information (customer image, customer features, etc.), together with the ordered articles, is displayed, the customer as the service destination can be certainly recognized when the articles are served.

Incidentally, among the ordered articles displayed on the kitchen display 13, an article served to the customer by the waitperson (or an article provided from the kitchen) is subjected to an operation of erasure (deletion from the list). The kitchen display 13 notifies the order station 10 of the article which was subjected to the erasure operation.

Besides, when receiving the transmission request for the customer management data, together with the designation of the table number, from the handy terminal 16 (Yes at Act D5), the order station 10 transmits the customer management data with the table number to the handy terminal 16 as the request source (Act D6).

Besides, if the customer management data is updated, for example, if the addition of a new customer or addition of an ordered article is performed in the handy terminal 16, or the erasure operation is performed in the kitchen display 13 (Yes at Act D7), the order station 10 updates the customer management data (ordered article data), and transmits the customer management data (ordered article data) to the kitchen printer 12 and the kitchen display 13 (Act D9). When the erasure operation is performed, data representing that the service is already performed is added to the ordered article data.

Besides, the order station 10 refers to the terminal management data to determine the handy terminal 16 recording the updated customer management data, and transmits the updated customer management data (update data) to this handy terminal 16.

When receiving the updated customer management data (update data) from the order station 10 (FIG. 18, Yes at Act C1), the handy terminal 16 updates the customer management data with the table number (Act C2).

Besides, if an accounting request, together with the designation of the table number, is received from the POS terminal 11 (Yes at Act D10), the order station 10 transmits the customer management data with the table number to the POS terminal 11 (Act D11). The POS terminal 11 displays data necessary for accounting based on the customer management data received from the order station 10, and an operation for an accounting process to the customer is performed. Here, not only the data such as the ordered article and the sum are displayed, but also the list of the ordered article data and the total sum are displayed for each customer, and the customer image may be displayed. The waitperson who performs the accounting process sees the displayed customer image, and can confirm the customer to perform accounting.

The POS terminal 11 notifies the order station 10 of the customer management data (table number) in which the accounting process is completed. The order station 10 deletes the customer management data recorded in the recording device 43 according to the notification, and further, refers to the terminal management data and instructs the handy terminal 16, which records the customer management data with the table number in which the accounting process is completed, to delete the customer management data (Act D12).

When receiving the delete instruction, together with the table number, from the order station 10 (FIG. 18, Yes at Act C3), the handy terminal 16 deletes the customer management data (including the customer image data) of the specified table number (Act C4).

In this way, the customer management data of the table in which the accounting process is completed, together with the customer image data, can be certainly deleted, and therefore, the customer image is made to be used only in the store, and the leakage of the personal information can be certainly avoided.

In this way, in the handy terminal 16 in the embodiment, the customer image and the customer information including the ordered article data are correlated and recorded, and can be arbitrarily displayed and confirmed. Thus, the relation between the customer and the information acquired from the customer can be easily grasped.

Incidentally, in the foregoing description, although the process of clipping the customer image from the image photographed by the camera unit 24 of the handy terminal 16 is performed in the handy terminal 16, the process may be performed in the order station 10. In this case, when photographing the image including the customer, the handy terminal 16 transmits the image data to the order station 10 through the wireless communication unit 33.

The order station 10 clips the customer image for each customer from the image data received from the handy terminal 16 by the same process as the foregoing, and calculates the respective seat positions. The order station 10 transmits the calculated seat positions and the customer image data corresponding thereto to the handy terminal 16. The handy terminal 16 can display the customer image, together with the table layout image, based on the customer image data received from the order station 10.

When receiving the customer information (ordered article data, customer feature data, etc.) made to correspond to the customer image in the handy terminal 16, the order station 10 correlates the customer information with the customer image and records the customer information in the same way as the foregoing.

In this way, since the image process having a large processing load is performed by the order station 10, the process load of the handy terminal 16 can be reduced. Thus, the performance requested for the handy terminal 16 is reduced, and the cost can be reduced.

Besides, in the foregoing description, although the customer image displayed on the touch screen display 25 (LCD 37) is displayed in the previously determined size, for example, the customer image specified by the touch operation may be enlarged and displayed according to the instruction of enlargement display, so that the details of the image can be confirmed.

Besides, in the foregoing description, although the description is made while the handy terminal 16 used in the restaurant or the like is used as an example, another portable electronic apparatus may be used. This electronic apparatus has to include only a camera unit and a function (processor, memory, etc.) to process an image photographed by the camera unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
camera configured to photograph an image;
image clipping unit configured to clip a customer image from the image photographed by the camera;
information input unit configured to input customer information which is made to correspond to the customer image and;
recording unit configured to record the customer image with the customer information; and
display configured to display the customer image and the customer information.

2. The apparatus of claim 1, further comprising layout determining unit configured to determine a layout of the customer image based on the image photographed by the camera, wherein
the display displays the customer image according to the layout.

3. The apparatus of claim 2, further comprising layout changing unit configured to change an arrangement of the customer image displayed by the display according to a user operation.

4. The apparatus of claim 1, further comprising:
communication unit configured to communicate with an external apparatus; and
transmission unit configured to transmit the customer image and the customer information recorded in the recording unit to the external apparatus through the communication unit.

5. The apparatus of claim 4, further comprising update data reception unit configured to receive update data of the customer image and the customer information recorded in the recording unit from the external apparatus through the communication unit, wherein the recording unit records the customer image and the customer information corresponding to the update data.

6. The apparatus of claim 4, wherein the recording unit classifies and records the customer image and the customer information for each specific place where the image is photographed by the camera.

7. The apparatus of claim 6, further comprising delete instruction reception unit configured to receive a delete instruction of information corresponding to the specific place from the external apparatus through the communication unit, wherein
the customer image and the customer information recorded in the recording unit are deleted according to the delete instruction.

8. The apparatus of claim 7, further comprising reception unit configured to receive a customer image and customer information correlated with the customer image from the external apparatus through the communication unit, wherein
the recording unit correlates and records the customer image with the customer information received by the reception unit.

9. The apparatus of claim 8, further comprising update data reception unit configured to receive update data of the customer image and the customer information recorded in the recording unit from the external apparatus through the communication unit, wherein
the recording unit records the customer image and the customer information corresponding to the update data.

10. An information processing apparatus comprising:
communication unit configured to communicate with an electronic apparatus;
image reception unit configured to receive an image through the communication unit;
image clipping unit configured to clip a customer image from the image received by the image reception unit;
transmission unit configured to transmit the customer image to the electronic apparatus through the communication unit;
information reception unit configured to receive customer information made to correspond to the customer image from the electronic apparatus through the communication unit; and
recording unit configured to record the customer image with the customer information.

11. The apparatus of claim 10, further comprising layout determining unit configured to determine a layout of the customer image based on the image received by the image reception unit, wherein
the recording unit records data representing the layout of the customer image.

12. An image processing method comprising:
photographing an image;
clipping a customer image from the image;
inputting customer information which is made to correspond to the customer image;
recording the customer image with the customer information; and
displaying the customer image and the customer information.

13. The method of claim 12, further comprising:
determining a layout of the customer image based on the photographed image; wherein
the customer image is displayed according to the layout.

14. The method of claim 13, further comprising:
changing an arrangement of the customer image according to a user operation.

15. The method of claim 12, further comprising:
transmitting the customer image and the customer information to an external apparatus.

16. The method of claim 15, further comprising:
receiving update data of the customer image and the customer information from the external apparatus, wherein
the customer image and the customer information corresponding to the update data are recorded.

17. The method of claim 15, wherein the customer image and the customer information are classified for each specific place where the image is photographed and are recorded.

18. The method of claim 12, further comprising:
receiving a customer image and customer information correlated with the customer image from an external apparatus, wherein
the customer image and the customer information are correlated and recorded.
